(19) United States
(12) Patent Application Publication
(10) Pub. No.: US 2020/0034474 A1
(43) Pub. Date: Jan. 30, 2020

(54) CREATING IDENTICAL SNAP PAIRS DURING SYNC REPLICATION WITH NO PERFORMANCE IMPACT

(71) Applicant: EMC IP Holding Company LLC, Hopkinton, MA (US)

(72) Inventors: Xiangping Chen, Sherborn, MA (US); Yuval Harduf, Yehud (IL); Ying Hu, Northborough, MA (US)

(73) Assignee: EMC IP Holding Company LLC, Hopkinton, MA (US)

(21) Appl. No.: 16/048,767

(22) Filed: Jul. 30, 2018

(51) Int. Cl. G06F 17/30

(52) U.S. Cl. CPC G06F 17/30581

(57) ABSTRACT

In one aspect, identical snap set creation in a sync replication environment includes creating a snap set (S-base) on a source site, marking, in a journal, valid sync replication IO journal entries at time of snap set creation, and tracking journal entries. Upon determining all marked sync replication IO journal entries are removed from the journal indicating completion of inflight IOs, an aspect further includes creating a snap set (S-base′) on the target site, creating a local snap set Sn against the source and a remote snap set against the S-base, transferring a data difference between Sn and S-base to the target site, and writing the difference to Sn′ on the target site.

### BACKGROUND

Maintaining synchronized snap set pairs (also referred to as “identical snap set pairs) between a source system and a target system is useful in remote replication environments. The identical snap set pairs can be used for data verification, fast recovery after replications session termination or disaster, or efficient synchronized restore/rollback operations between the source and target.

Identical snap set pairs are easy to create in asynchronous snap-based replication. Since the read only snap sets are replicated to the target in each replication cycle, at the end of each cycle, the result is the same snap set is stored on the target as on the source. In sync replication, however, it is more challenging as data gets replicated constantly from the source consistency group to the target consistency group. At any given time, there are always IOs inflight that might make the source system and target system different. Conventionally, due to constant inflight IO changes between the source and target in sync replication, to create synchronized snap set one has to suspend and drain source host IOs to safely create a synchronized snap set pair.

### SUMMARY

This Summary is provided to introduce a selection of concepts in a simplified form that are further described herein in the Detailed Description. This Summary is not intended to identify key features or essential features of the claimed subject matter, nor is it intended to be used to limit the scope of the claimed subject matter.

One aspect may provide a method for creating identical snap pairs in synchronous replication environment. The method includes creating a snap set (S-base) on a source site, marking, in a journal, valid sync replication IO journal entries at time of snap set creation, and tracking journal entries. Upon determining all marked sync replication IO journal entries are removed from the journal indicating completion of inflight IOs, the method further includes creating a snap set (S-base′) on the target site, creating a local snap set Sn against the source and a remote snap set against the S-base, transferring a data difference between Sn and S-base to the target site, and writing the difference to Sn′ on the target site.

Another aspect may provide a system for creating identical snap pairs in synchronous replication environment. The system includes a memory having computer-executable instructions. The system also includes a processor operated by a storage system. The processor executes the computer-executable instructions. When executed by the processor, the computer-executable instructions cause the processor to perform operations. The operations include creating a snap set (S-base) on a source site, marking, in a journal, valid sync replication IO journal entries at time of snap set creation, and tracking journal entries. Upon determining all marked sync replication IO journal entries are removed from the journal indicating completion of inflight IOs, the operations further include creating a snap set (S-base′) on the target site, creating a local snap set Sn against the source and a remote snap set against the S-base, transferring a data difference between Sn and S-base to the target site, and writing the difference to Sn′ on the target site.

Another aspect may provide a computer program product embodied on a non-transitory computer readable medium. The computer program product includes instructions that, when executed by a computer at a storage system, causes the computer to perform operations. The operations include creating a snap set (S-base) on a source site, marking, in a journal, valid sync replication IO journal entries at time of snap set creation, and tracking journal entries. Upon determining all marked sync replication IO journal entries are removed from the journal indicating completion of inflight IOs, an aspect further includes creating a snap set (S-base′) on the target site, creating a local snap set Sn against the source and a remote snap set against the S-base, transferring a data difference between Sn and S-base to the target site, and writing the difference to Sn′ on the target site.

### BRIEF DESCRIPTION OF THE DRAWING FIGURES

Objects, aspects, features, and advantages of embodiments disclosed herein will become more fully apparent from the following detailed description, the appended claims, and the accompanying drawings in which like reference numerals identify similar or identical elements. Reference numerals that are introduced in the specification in association with a drawing figure may be repeated in one or more subsequent figures without additional description in the specification in order to provide context for other features. For clarity, not every element may be labeled in every figure. The drawings are not necessarily to scale, emphasis instead being placed upon illustrating embodiments, principles, and concepts. The drawings are not meant to limit the scope of the claims included herewith.

FIG. 1 is a block diagram of a storage system to perform identical snap set pair creation in a synchronous replication environment in accordance with an illustrative embodiment;

FIG. 2 is a block diagram of another storage system to perform identical snap set pair creation in a synchronous replication environment in accordance with an illustrative embodiment;

FIG. 3 is a flow diagram of a process to perform identical snap set pair creation in a synchronous replication environment in accordance with an illustrative embodiment;

FIG. 4 is a block diagram of a hardware device that may perform at least a portion of the process shown in FIG. 3; and

FIG. 5 a simplified block diagram of an apparatus that may be used to implement at least a portion of the systems of FIGS. 1-2 and 4 and at least a portion of the process of FIG. 3.

### DETAILED DESCRIPTION

Embodiments described herein provide a way to create identical snap set pairs in a synchronous replication environment of a storage system. The identical snap set pair creation process provides a way to create synchronized identical snap set pairs on a source and target system with minimum interruption of both ongoing host IO operations and sync replication IO activities, and without the need to suspend and drain IO before snap set creation.

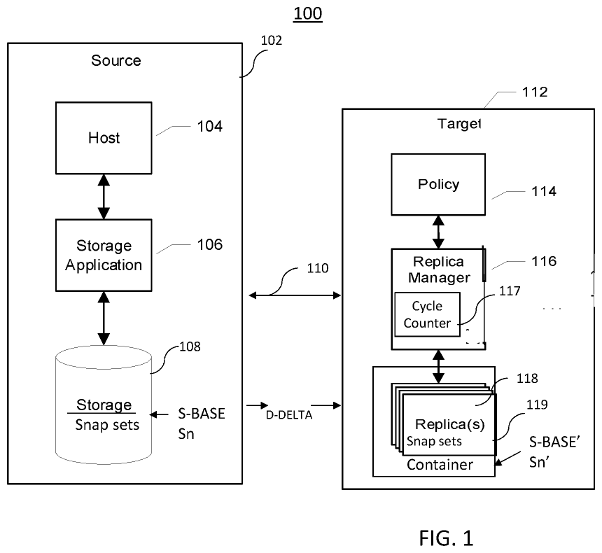

Turning now to FIG. 1, an example storage system 100 for implementing identical snap set pairs creation processes in a synchronous replication environment will now be described. Storage system 100 may include at least one source site 102 and at least one target site 112. In an embodiment, target site 112 is either co-located with source site 102 or is in close geographic proximity (e.g., within the same building or building complex) with the source site 102. In other embodiments, target site 112 is remotely located from the source site 102. For example, target site 112 may be geographically dispersed across cities, states, or even countries with respect to source site 102.

Source site 102 may include a host 104, storage application 106, and data storage 108. In some embodiments, storage 108 may include one or more storage volumes (not shown), that operate as active or production volumes.

Host 104 may perform I/O operations on storage 108 (e.g., read data from and write data to storage 108). In some embodiments, the I/O operations may be intercepted by and controlled by the storage application 106. As changes are made to data stored on storage 108 via the I/O operations from host 104, or over time as storage system 100 operates, storage application 106 may perform data replication from the source site 102 to the target site 112 over a communication network 110. In some embodiments, the communication network 110 may include internal (e.g., short distance) communication links (not shown) to transfer data between storage volumes for storing replicas 107 and 118 (also referred to herein as snap sets), such as an InfiniBand (IB) link or Fibre Channel (FC) link. In other embodiments, the communication link 110 may be a long-distance communication network of a storage area network (SAN), e.g., over an Ethernet or Internet (e.g., TCP/IP) link that may employ, for example, the iSCSI protocol.

In illustrative embodiments, storage system 100 may employ a snap set (or replication) mechanism to replicate data between source site 102 and target site 112. A snap set (or replica) may be created from data within storage 108 and transferred to the target site 112 during a data replication cycle by data replication.

Data replication may be performed based on data replication policies that may define various settings for data recovery operations, shown as policy 114 in target site 112. For example, policy 114 may define a plurality of attributes, such as a frequency with which replicas are generated and how long each replica 118 is kept at target site 112. In some embodiments, policy 114 defines metrics for use in snap set creation and replication process determinations. For example, metrics include a minimum snap set creation interval, a maximum snap set creation interval, and a recovery time threshold.

As described herein, in example embodiments, data replication may be synchronous data replication with snap sets created in dynamic intervals during operation of storage system 100. The timing of synchronous replication cycles and the retention of the replicas 118 may be managed by replica manager 116 of target site 112.

In addition to managing replicas 118 according to a policy 114 (e.g., a replication and/or retention policy), the replica manager 116 may also include a cycle counter 117 to track generations of snap sets over time, as will be described further herein.

It will be understood that the roles of the source site 102 and the target site 112 may be reversed in instances, e.g., in which an event occurring on the source site 102 causes the target site 112 to intercept I/Os and take on the role of snap set creation and replication to the source site. This role reversal is referred to as a failover event. In this manner, the processes described herein apply equally to the target site.

In embodiments, the identical snap set pair creation process leverages the use of a sync replication IO journal. The journal may be stored at any dedicated location in the storage system of FIG. 1 as long as it is subject to data protection tools.

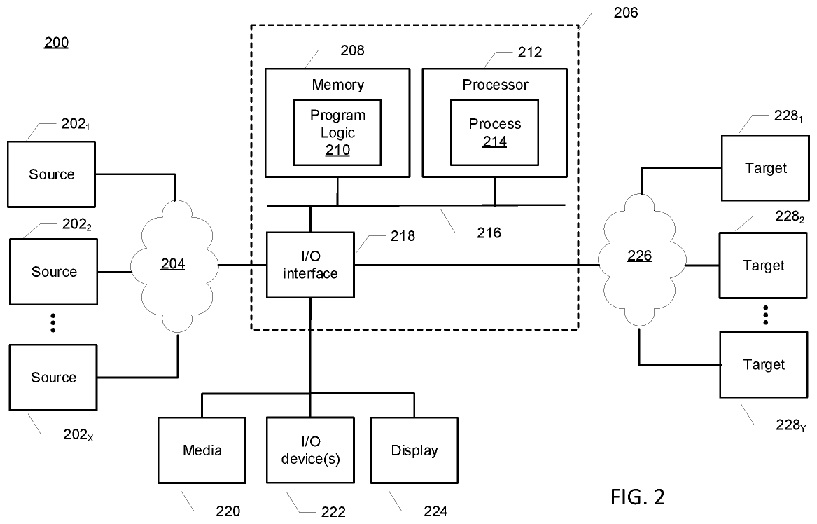

Referring to FIG. 2, in an illustrative embodiment, an apparatus 206 may form part of system 200 and include a memory 208 storing program logic 210, a processor 212 for executing a process 214, and a communications I/O interface 218, connected via a bus 216 to allow communication between memory 208, processor 212 and devices external to apparatus 206. Apparatus 206 may correspond to elements of the source site 102 of FIG. 1. For example, in some embodiments, communications I/O interface 218 may be coupled to apparatus 206, external media 220, one or more I/O devices 222, and a display device 224. In some embodiments, communications I/O interface 218 may couple apparatus 206 to one or more source devices 202₁-202_{X} via a network 204. Source devices 202₁-202_{X} may correspond to elements of the source site 102 in FIG. 1. In some embodiments, communications I/O interface 218 may couple apparatus 206 to one or more target devices 228₁-228_{Y} via networks 226. Target devices 228₁-228_{Y} may correspond to elements of the target site 112 in FIG. 1. In some embodiments, networks 226 of FIG. 2 may include a communication fabric between volumes of targets 228. For example, in some embodiments, networks 226 may include an InfiniBand (IB) network or a Fibre Channel (FC) network. Networks 226 may also include a long-distance communication network of a storage area network (SAN), e.g., over an Ethernet or Internet (e.g., TCP/IP) link that may employ, for example, the iSCSI protocol.

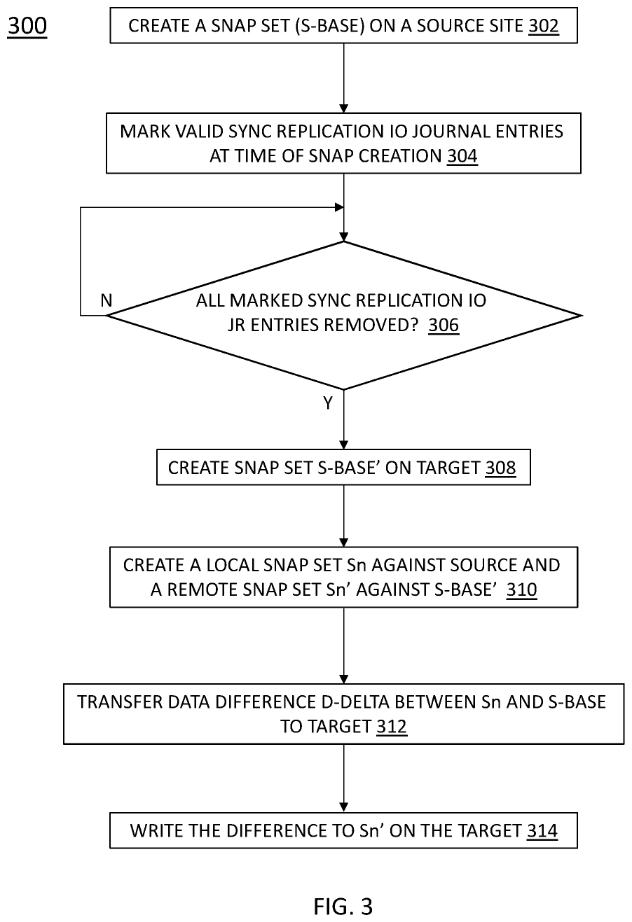

Turning now to FIG. 3, a process 300 for implementing the identical snap set pair creation in a synchronous replication environment will now be described in accordance with illustrative embodiments. The process 300 may be implemented, e.g., by the storage application 106 of FIG. 1. In the process of FIG. 3, a source system refers to a source site (e.g., site 102 of FIG. 1) or a source device 202 of FIG. 2. A target system refers to a target site 112 of FIG. 1 or one of target devices 228 of FIG. 2.

In block 302, the process 300 creates a snap set (S-base) on the source site.

In block 304, the process 300 marks the valid sync replication IO journal entries at the time of snap creation. Each journal entry represents an inflight 10 request. When a journal entry is allocated to track inflight sync IO, the entry becomes valid. If marking is needed due to snap set creation, then all the existing valid journal entries are marked. Once the IO is complete, the entry becomes invalid and unmarked. A sample journal table is shown below in a non-limiting embodiment.

JOURNAL TABLE

| IO # or ID | IO info | IO info | IO info | Mark? |
|---|---|---|---|---|
| 1 | Write | Sync rep in | Need mark | yes |
| | (address, extent) | progress | | |
| 2 | Trim | Replication done | Need mark | No |
| | (address, extent) | | | |
| 3 | Write | Sync replication | No need | No |
| | (address, extent) | in progress | to mark | |

In block 306, it is determined whether all marked sync replication IO journal entries are removed (e.g., all marked inflight IOs are completed). By completed, this means that they have been successfully transmitted to the source or target.

If so, in block 308, the process 300 creates a snap set S-base′ on the target site. The S-base′ contains all of the content of the S-base, since all of the inflight IOs at the time of S-base creation have completed before the S-base′ creation. However, there may be other IOs completed while waiting for inflight IO completion (all marked journal entries cleared), which is why S-base′>=S-base. Otherwise, if not all marked sync replication IO journal entries have been removed, the process 300 continues to track the journal entries.

In block 310, the process 300 creates a local snap set Sn against the source and a remote snap set Sn′ against the S-base′. The remote target snap set Sn′ is a paired object of Sn created on the local source. In sync replication, data updates are replicated from a source storage group to a target. If a snap set is created against a source, it means that a snap set of the point in time content of the replication source storage object is created. The S-base′ is created prior to Sn and Sn′ so its content is less than Sn and is used as a base for Sn′. If a remote snap set Sn is created against the S-base′, and S-base′>=S_base, add (Sn-S-base) on top of S-base′, the resulting Sn′ will be equivalent to Sn. In other words, Sn′=S-base′+(Sn-S-base)=Sn.

In block 312, the process 300 transfers the data difference (D-delta) between Sn and S-base to the target. In block 314, the process 300 writes the difference to Sn′ on the target. Since the S-base<=S-base′, and Sn=S-base+D-delta, once the data difference transfer is complete, the result is Sn′=S-base′+D-delta==Sn.

Since the source IO is not suspended during this process 300, the data D-delta is essentially transferred twice, once to the target site via sync replication IO, and once to S-n′ via the special async delta transfer described above. With the capability of marking inflight IOs through sync replication IO journal, and creating a snap set right after the short window of marked inflight IOs complete, the data needed to retransmit is kept at a minimum.

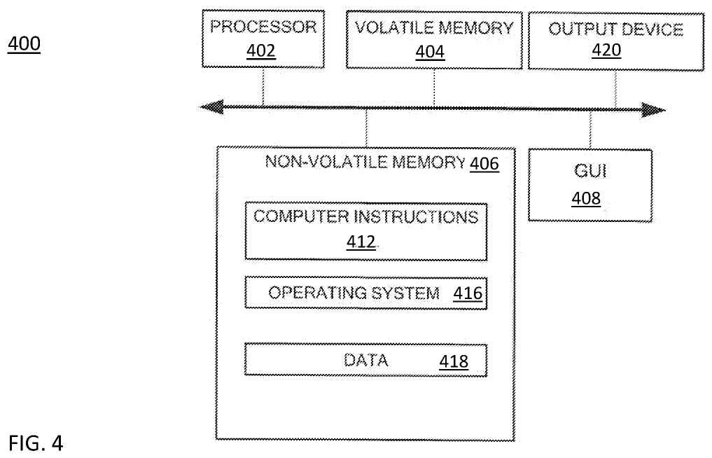

Referring to FIG. 4, in some embodiments, the source site 102 and/or target site 112 may be implemented as one or more computers. Computer 400 may include processor 402, volatile memory 404 (e.g., RAM), non-volatile memory 406 (e.g., a hard disk drive, solid state drive such as a flash drive, a hybrid magnetic and solid state drive, etc.), graphical user interface (GUI) 408 (e.g., a mouse, a keyboard, a display, and so forth) and input/output (I/O) device 420. Non-volatile memory 406 stores computer instructions 412, an operating system 416 and data 418 such that, for example, the computer instructions 412 are executed by the processor 402 out of volatile memory 404 to perform at least a portion of the process 300 shown in FIG. 3. Program code may be applied to data entered using an input device of GUI 408 or received from I/O device 420.

Process 300 shown in FIG. 3 is not limited to use with the hardware and software of FIG. 4 and may find applicability in any computing or processing environment and with any type of machine or set of machines that is capable of running a computer program. Process 300 shown in FIG. 3 may be implemented in hardware, software, or a combination of the two.

The processes described herein are not limited to the specific embodiments described. For example, process 300 is not limited to the specific processing order shown in FIG. 3. Rather, one or more blocks of process 300 may be re-ordered, combined or removed, performed in parallel or in serial, as necessary, to achieve the results set forth herein.

Processor 402 may be implemented by one or more programmable processors executing one or more computer programs to perform the functions of the system. As used herein, the term “processor” is used to describe an electronic circuit that performs a function, an operation, or a sequence of operations. The function, operation, or sequence of operations can be hard coded into the electronic circuit or soft coded by way of instructions held in a memory device. A “processor” can perform the function, operation, or sequence of operations using digital values or using analog signals. In some embodiments, the “processor” can be embodied in an application specific integrated circuit (ASIC). In some embodiments, the “processor” can be embodied in a microprocessor with associated program memory. In some embodiments, the “processor” can be embodied in a discrete electronic circuit. The “processor” can be analog, digital or mixed-signal.

While illustrative embodiments have been described with respect to processes of circuits, described embodiments may be implemented as a single integrated circuit, a multi-chip module, a single card, or a multi-card circuit pack. Further, as would be apparent to one skilled in the art, various functions of circuit elements may also be implemented as processing blocks in a software program. Such software may be employed in, for example, a digital signal processor, micro-controller, or general purpose computer. Thus, described embodiments may be implemented in hardware, a combination of hardware and software, software, or software in execution by one or more processors.

Some embodiments may be implemented in the form of methods and apparatuses for practicing those methods. Described embodiments may also be implemented in the form of program code, for example, stored in a storage medium, loaded into and/or executed by a machine, or transmitted over some transmission medium or carrier, such as over electrical wiring or cabling, through fiber optics, or via electromagnetic radiation. A non-transitory machine-readable medium may include but is not limited to tangible media, such as magnetic recording media including hard drives, floppy diskettes, and magnetic tape media, optical recording media including compact discs (CDs) and digital versatile discs (DVDs), solid state memory such as flash memory, hybrid magnetic and solid state memory, non-volatile memory, volatile memory, and so forth, but does not include a transitory signal per se. When embodied in a non-transitory machine-readable medium, and the program code is loaded into and executed by a machine, such as a computer, the machine becomes an apparatus for practicing the method.

When implemented on a processing device, the program code segments combine with the processor to provide a unique device that operates analogously to specific logic circuits. Such processing devices may include, for example, a general purpose microprocessor, a digital signal processor (DSP), a reduced instruction set computer (RISC), a complex instruction set computer (CISC), an application specific integrated circuit (ASIC), a field programmable gate array (FPGA), a programmable logic array (PLA), a microcontroller, an embedded controller, a multi-core processor, and/or others, including combinations of the above. Described embodiments may also be implemented in the form of a bitstream or other sequence of signal values electrically or optically transmitted through a medium, stored magnetic-field variations in a magnetic recording medium, etc., generated using a method and/or an apparatus as recited in the claims.

Various elements, which are described in the context of a single embodiment, may also be provided separately or in any suitable subcombination. It will be further understood that various changes in the details, materials, and arrangements of the parts that have been described and illustrated herein may be made by those skilled in the art without departing from the scope of the following claims.

In the above-described flow chart of FIG. 3, rectangular elements, herein denoted “processing blocks,” represent computer software instructions or groups of instructions. Alternatively, the processing blocks may represent steps performed by functionally equivalent circuits such as a digital signal processor (DSP) circuit or an application specific integrated circuit (ASIC). The flow diagram does not depict the syntax of any particular programming language but rather illustrate the functional information one of ordinary skill in the art requires to fabricate circuits or to generate computer software to perform the processing required of the particular apparatus. It should be noted that many routine program elements, such as initialization of loops and variables and the use of temporary variables may be omitted for clarity. The particular sequence of blocks described is illustrative only and can be varied without departing from the spirit of the concepts, structures, and techniques sought to be protected herein. Thus, unless otherwise stated, the blocks described below are unordered meaning that, when possible, the functions represented by the blocks can be performed in any convenient or desirable order.

Some embodiments may be implemented in the form of methods and apparatuses for practicing those methods. Described embodiments may also be implemented in the form of program code, for example, stored in a storage medium, loaded into and/or executed by a machine, or transmitted over some transmission medium or carrier, such as over electrical wiring or cabling, through fiber optics, or via electromagnetic radiation. A non-transitory machine-readable medium may include but is not limited to tangible media, such as magnetic recording media including hard drives, floppy diskettes, and magnetic tape media, optical recording media including compact discs (CDs) and digital versatile discs (DVDs), solid state memory such as flash memory, hybrid magnetic and solid state memory, non-volatile memory, volatile memory, and so forth, but does not include a transitory signal per se. When embodied in a non-transitory machine-readable medium and the program code is loaded into and executed by a machine, such as a computer, the machine becomes an apparatus for practicing the method.

When implemented on one or more processing devices, the program code segments combine with the processor to provide a unique device that operates analogously to specific logic circuits. Such processing devices may include, for example, a general purpose microprocessor, a digital signal processor (DSP), a reduced instruction set computer (RISC), a complex instruction set computer (CISC), an application specific integrated circuit (ASIC), a field programmable gate array (FPGA), a programmable logic array (PLA), a microcontroller, an embedded controller, a multi-core processor, and/or others, including combinations of one or more of the above. Described embodiments may also be implemented in the form of a bitstream or other sequence of signal values electrically or optically transmitted through a medium, stored magnetic-field variations in a magnetic recording medium, etc., generated using a method and/or an apparatus as recited in the claims.

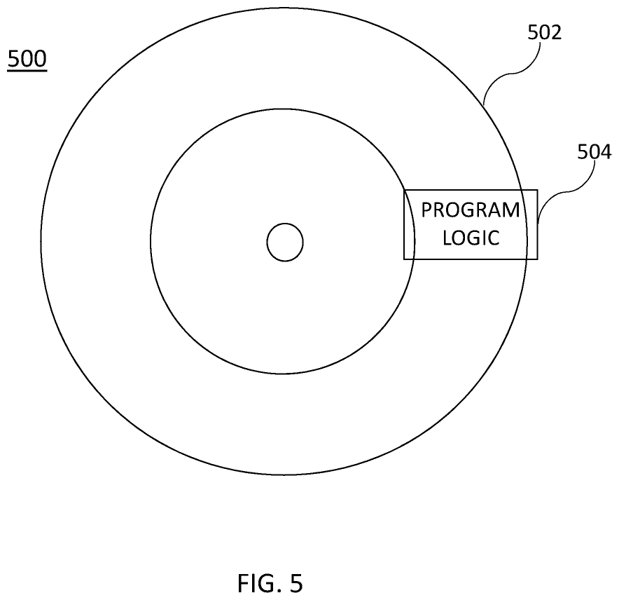

For example, when the program code is loaded into and executed by a machine, such as the computer of FIG. 4, the machine becomes an apparatus for practicing the invention. When implemented on one or more general-purpose processors, the program code combines with such a processor to provide a unique apparatus that operates analogously to specific logic circuits. As such a general-purpose digital machine can be transformed into a special purpose digital machine. FIG. 5 shows Program Logic 504 embodied on a computer-readable medium 502 as shown, and wherein the Logic is encoded in computer-executable code configured for carrying out the reservation service process of this invention and thereby forming a Computer Program Product 500. The logic may be the same logic on memory loaded on processor. The program logic may also be embodied in software modules, as modules, or as hardware modules. A processor may be a virtual processor or a physical processor. Logic may be distributed across several processors or virtual processors to execute the logic.

In some embodiments, a storage medium may be a physical or logical device. In some embodiments, a storage medium may consist of physical or logical devices. In some embodiments, a storage medium may be mapped across multiple physical and/or logical devices. In some embodiments, storage medium may exist in a virtualized environment. In some embodiments, a processor may be a virtual or physical embodiment. In some embodiments, a logic may be executed across one or more physical or virtual processors.

For purposes of illustrating the present embodiment, the disclosed embodiments are described as embodied in a specific configuration and using special logical arrangements, but one skilled in the art will appreciate that the device is not limited to the specific configuration but rather only by the claims included with this specification. In addition, it is expected that during the life of a patent maturing from this application, many relevant technologies will be developed, and the scopes of the corresponding terms are intended to include all such new technologies a priori.

The terms “comprises,” “comprising”, “includes”, “including”, “having” and their conjugates at least mean “including but not limited to”. As used herein, the singular form “a,” “an” and “the” includes plural references unless the context clearly dictates otherwise. Various elements, which are described in the context of a single embodiment, may also be provided separately or in any suitable subcombination. It will be further understood that various changes in the details, materials, and arrangements of the parts that have been described and illustrated herein may be made by those skilled in the art without departing from the scope of the following claims.

We claim:

1. A method, comprising:
creating a snap set (S-base) on a source site;
marking, in a journal, valid sync replication IO journal entries at time of snap set creation;
tracking journal entries; and
upon determining all marked sync replication IO journal entries are removed from the journal indicating completion of inflight IOs:
creating a snap set (S-base′) on the target site;
creating a local snap set Sn against the source and a remote snap set against the S-base;
transferring a data difference between Sn and S-base to the target site; and
writing the difference to Sn′ on the target site.

2. The method of claim 1, wherein the valid sync replication IO journal entries indicate corresponding journal entries are allocated to track inflight sync IO, and the entries become valid.

3. The method of claim 1, wherein each journal entry represents an inflight IO request.

4. The method of claim 1, wherein the local snap set Sn against the source indicates a snap set of a point in time content of a replication source storage object is created.

5. The method of claim 1, wherein creating a remote snap set (Sn) against the S-base′, where S-base′>=S-base, includes adding (Sn-S-base) on top of the S-base′, resulting in Sn′=Sn.

6. The method of claim 1, wherein the S-base has less than or equal to an amount of data as the S-base′.

7. A system, comprising:
a memory comprising computer-executable instructions; and
a processor operable by a storage system, the processor executing the computer-executable instructions, the computer-executable instructions when executed by the processor cause the processor to perform operations comprising:
creating a snap set (S-base) on a source site;
marking, in a journal, valid sync replication IO journal entries at time of snap set creation;
tracking journal entries; and
upon determining all marked sync replication IO journal entries are removed from the journal indicating completion of inflight IOs:
creating a snap set (S-base′) on the target site;
creating a local snap set Sn against the source and a remote snap set against the S-base;
transferring a data difference between Sn and S-base to the target site; and
writing the difference to Sn′ on the target site.

8. The system of claim 7, wherein the valid sync replication IO journal entries indicate corresponding journal entries are allocated to track inflight sync IO, and the entries become valid.

9. The system of claim 7, wherein each journal entry represents an inflight IO request.

10. The system of claim 7, wherein the local snap set Sn against the source indicates a snap set of a point in time content of a replication source storage object is created.

11. The system of claim 7, wherein creating a remote snap set (Sn) against the S-base′, where S-base′>=S-base, includes adding (Sn-S-base) on top of the S-base′, resulting in Sn′=Sn.

12. The system of claim 7, wherein the S-base has less than or equal to an amount of data as the S-base′.

13. A computer program product embodied on a non-transitory computer readable medium, the computer program product including instructions that, when executed by a computer, causes the computer to perform operations comprising:
creating a snap set (S-base) on a source site;
marking, in a journal, valid sync replication IO journal entries at time of snap set creation;
tracking journal entries; and
upon determining all marked sync replication IO journal entries are removed from the journal indicating completion of inflight IOs:
creating a snap set (S-base′) on the target site;
creating a local snap set Sn against the source and a remote snap set against the S-base;
transferring a data difference between Sn and S-base to the target site; and
writing the difference to Sn′ on the target site.

14. The computer program product of claim 13, wherein the valid sync replication IO journal entries indicate corresponding journal entries are allocated to track inflight sync IO, and the entries become valid.

15. The computer program product of claim 13, wherein each journal entry represents an inflight IO request.

16. The computer program product of claim 13, wherein the local snap set Sn against the source indicates a snap set of a point in time content of a replication source storage object is created.

17. The computer program product of claim 13, wherein creating a remote snap set (Sn) against the S-base′, where S-base′>=S-base, includes adding (Sn-S-base) on top of the S-base′, resulting in Sn′=Sn.

18. The computer program product of claim 13, wherein the S-base has less than or equal to an amount of data as the S-base′.
